(19) United States
(12) Patent Application Publication
(10) Pub. No.: US 2003/0027101 A1
(43) Pub. Date: Feb. 6, 2003

(54) BRUSH FOR CLEANING BETWEEN THE TEETH

(76) Inventor: Estela Victoria, Monterey Park, CA (US)

Correspondence Address: George J. Netter, Esq., LAW OFFICES OF GEORGE J. NETTER, 260 S. Los Robles Ave., #216, Pasadena, CA, 91101, US

(21) Appl. No.: 09/922,557

(22) Filed: Aug. 6, 2001

(51) Int. Cl. A61C 3/06

(52) U.S. Cl. 433/142; 433/216

(57) ABSTRACT

A dental brush (10) especially for cleaning and stimulating tissues between the teeth includes a core (12) with filaments (14) extending outwardly away from the core in a large variety of different angles, the outer ends of the filaments lying within a triangle as viewed along the core axis. When viewed into the side of the core (12), the filaments (14) extend away from the core at a maximum in the central region of the core and have a continually reducing extent as they are spaced away from the central region toward the core ends (16, 18).

### BACKGROUND

1. Field of the Invention

The present invention relates generally to a brush for cleaning between the teeth, and, more particularly, to such a brush having enhanced cleaning abilities and readily adaptable for use in a toothpick brush form or attached to the end of a handheld device.

2. Description of Related Art

It is well-known that removing foreign particles from between the teeth reduces the possibility of caries and the buildup of plaque which, in turn, leads to more serious gum diseases with possible ultimate loss of teeth. A typical approach to this problem is to have frequent sessions with a dental hygiene technician at which time already formed plaque is removed, cavities are noted, and further treatment called for can be scheduled. Perhaps more important, is to have individual home cleaning for removing foreign particles and deterring plaque buildup which is accomplished at least once and preferably several times a day.

The usual toothbrush with relatively large bristles is ill adapted for cleaning between the teeth and for the most part merely cleans the major outer surfaces of the teeth. There are provided on the market smaller brushes, both cylindrical and conical shaped, which can be utilized to clean between adjacent teeth. Although these latter brushes accomplish a measure of inter-teeth cleaning their efficiency of operation can be desirably improved especially where distinct pockets exist between adjacent teeth.

### SUMMARY OF THE INVENTION

In accordance with the practice of a first embodiment of the invention, an elongated, multi-filament brush has a brush configuration as seen from the side whose filaments increase in length as you move longitudinally inwardly from the outer brush end reaching a maximum extension intermediate the brush ends after which the filaments decrease in length until reaching a minimum at the brush inner end. Also, the brush is seen looking along the longitudinal axis to be triangular in shape. In use, it is contemplated that the brush will be inserted in the space between two adjacent teeth with the base or other side of the triangular brush being positioned adjacent the gum between the teeth. In cleaning, the brush is moved generally parallel to the brush longitudinal axis with a triangular side being located in a wider part of the intervening gap between teeth.

In a first embodiment, the individual brush elements are secured to a wire core and the core coated with a protective plastic material. In a second embodiment, the brush filaments and elongated central core are molded from a synthetic plastic material.

### BRIEF DESCRIPTION OF THE DRAWING

These and other aspects of the present invention will become more readily apparent upon reference to the following detailed description and upon reviewing the attached drawings, in which:

FIG. 1 is a side elevational view of a first embodiment of the described brush for cleaning between the teeth;

FIG. 2 is an end elevational, sectional view of the brush of FIG. 1;

FIG. 3 is side elevational, fragmentary view of an alternative embodiment of brush; and

FIG. 4 is a sectional view taken along the line 4-4 of FIG. 3.

### DESCRIPTION OF PREFERRED EMBODIMENTS

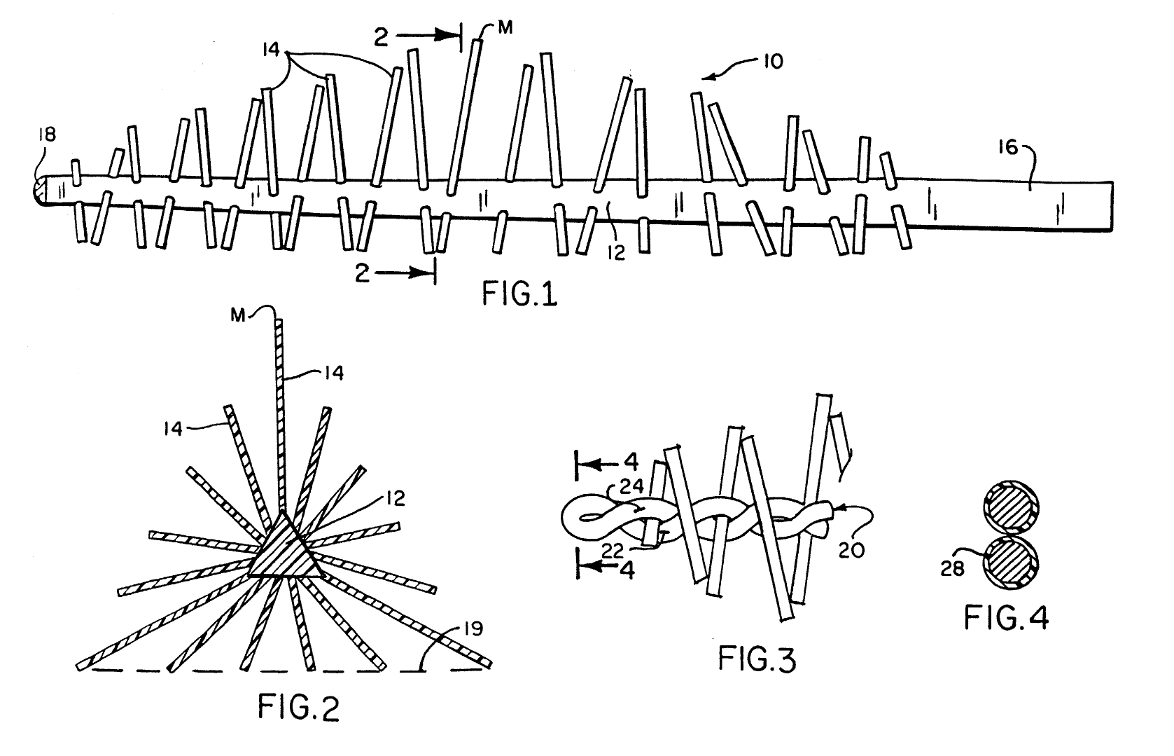

Turning now to the drawing and particularly FIG. 1, there is shown a first embodiment of a dental brush of the invention enumerated generally as 10 especially adapted for cleaning between the teeth of a human being. The brush includes a generally triangular cross-sectional core 12 having a plurality of brush filaments or “bristles” 14 that extend away from the core in a large variety of different angles. In this embodiment, it is contemplated that the filaments and core are unitarily molded from a synthetic plastic. Moreover, it is to be noted that the filaments are of graded lengths, beginning with minimum length filaments at the outermost brush end 16 that uniformly increase to a maximum filament length (M) generally centrally located along the core and then reduce uniformly to a minimum length at the opposite end 18 of the set of filaments.

Still further, as shown in FIG. 2 when seen looking into the brush end 16 and along the core, the set of brush elements form a triangle. In use, it is contemplated that one of the sides of the brush triangle preferably side 19 will be received within a space between adjacent teeth and face the intervening gum (not shown).

For an alternative embodiment, reference is made to FIG. 3 where a brush core 20 is shown formed of two wires 22 and 24 twisted together with appropriately dimensioned individual bristles 26 securely captured between the wires. The core and adjacent bristles captured end portions are enclosed within a protective synthetic plastic layer 28 to prevent damage to the gums and teeth by the wires during use. Otherwise, the geometry of the overall brush is the same as that of the first described embodiment.

In both embodiments it is contemplated that the outer core end 16 will be modified to facilitate holding in the fingers during use (not shown).

In use of the described tooth brush, it is inserted in the space between adjacent teeth with the end 18 leading and a flat side of the triangle (e.g., side 19) generally parallel to the gum existing between the teeth. The brush is then moved generally parallel to the core 12 which produces a thorough brushing of the adjacent teeth surfaces and gum by the filaments 14. It is important to note that the brushing direction of the individual filaments changes as you change the brush movement from push to pull thereby effecting a substantial enhancement of plaque removal and removal of food particles.

In a practical construction of the invention, the overall length of the dental brush was approximately 1.0 inch, the width 0.015 inches, the filament lengths varied from 0.015 to 0.260 inches, and the filament diameter was 0.003 inches.

Although the present invention is described in preferred embodiments, it is to be understood that those skilled in the appertaining art may contemplate of changes that come within the spirit of the described invention and within the ambit of the appended claims

What is claimed is:

1. A brush for cleaning between the teeth, comprising:
an elongated core having a longitudinal axis;
a plurality of brush filaments secured to the core means with each brush filament having an outer free end portion;
said brush filaments being of respective lengths and lines of extension away from the core means such that the outer free ends lie within a geometric envelope that appears as a triangle on looking along the core longitudinal axis and when viewed normally to the axis the brush filaments have a maximum extension from the core at a generally central region along the core axis with the brush filament extensions from the core reducing on moving along the axis away from the maximum extension.

2. A brush as in claim 1, in which the core and brush elements are unitarily constructed of a molded synthetic plastic material.

3. A brush as in claim 1, in which the core is constructed of a pair of wires unitarily twisted together and individual brush elements each have an end portion clampingly secured between the twisted wires.

4. A brush as in claim 2, in which the core axis is substantially straightline and the brush filaments extend away from the core at a variety of different angles to the core axis.

5. A brush as in claim 2, in which the core includes an end portion free from brush elements adapted to be held with the fingers.

6. A brush as in claim 1, in which the core has a triangular cross-section.
